(19) United States
(12) Patent Application Publication
(10) Pub. No.: US 2012/0328364 A1
(43) Pub. Date: Dec. 27, 2012

(54) DEVICE FOR RELEASABLE MOUNTING OF CABINETS OR THE LIKE TO FLOORS IN GALLEYS IN AIRPLANES

(76) Inventor: Maurice TKOCZ, Huettenberg (DE)

(21) Appl. No.: 13/570,610

(22) Filed: Aug. 9, 2012

Related U.S. Application Data
(63) Continuation-in-part of application No. 12/745,359, filed on Jun. 11, 2010, now abandoned.

(30) Foreign Application Priority Data
Mar. 18, 2008 (DE) 202008003772.7
Mar. 16, 2009 (EP) PCT/EP2009/001908

(51) Int. Cl. F16B 21/06

(52) U.S. Cl. 403/322.4

(57) ABSTRACT

An aircraft-floor rail formed with an upwardly open T-groove carries a piece of galley equipment via at least one mount having a base fixable on the piece of equipment and formed with an upper bearing surface and a vertically throughgoing bore opening at the surface. A block below the base engages downward into the T-groove and is with a vertically throughgoing bore aligned with the bore of the base. A T-nut fittable in and slidable along the T-groove is lockingly upwardly engageable with the rail. A bolt seated in the T-nut extends upward from the T-nut through the base and the locking block. A latch lever above the locking block can pull up the bolt and thereby lock the T-nut in the rail.

### CROSS REFERENCE TO RELATED APPLICATIONS

This application is a continuation-in-part of U.S. patent application Ser. No. 12/745,359 filed 6 Jun. 2010 as the US-national stage of PCT application PCT/EP2009/001908, filed 16 Mar. 2009, published 24 Sep. 2009 as WO2009/115271, and claiming the priority of German patent application 202008003772.7 itself filed 18 Mar. 2008, whose entire disclosures are herewith incorporated by reference.

### FIELD OF THE INVENTION

The invention relates to a device for releasable floor mounting of cabinets or similar built-in equipment to the floor of an aircraft galley on seat rails extending in the flight direction on the cabin floor.

### BACKGROUND OF THE INVENTION

Independent of the type of aircraft, a galley having several pieces of built-in equipment elements is installed near a door on floor rails extending either in the flight direction or transverse to the flight direction. Moreover, the galleys or its parts are mounted to the aircraft via the ceiling. Depending on load and forces within the galley, each of the floor mounts has to absorb forces in the X- and Y- as well as the Z-direction.

The mount known from previous practice uses screw connections installed with a predetermined torque. The mounting screws are primarily loaded by longitudinal forces, i.e. in the vertical Z-direction. To absorb forces acting in flight or the X-direction, and in the transverse or Z-direction, additional measures must be taken. These typical floor mounts using screw connections require considerable installation work and also special tools if seating capacity in the aircraft is to be varied. In fact, in this case, the entire galley has to be moved.

### OBJECT OF THE INVENTION

Thus, the object of the invention is to provide a mount of the above-mentioned type that allows a rearrangement of galleys in aircrafts in a simple manner and with significantly reduced time in order to provide space for further rows of seats, and that, at the same time, meets the high safety standards and absorbs the large forces occurring in the different directions.

### SUMMARY OF THE INVENTION

This object is attained according to the invention in that a quick-release mount receiving and supporting a kitchen unit comprises as parts, successively from top to bottom, a latch lever, a base, and a T-nut engaging in a T-groove of the seat rail, the parts being carried on a threaded bolt assembly provided centrally in aligned bores, being held together loosely in an untensioned state of the quick-release mount by an integrated spring, and allowing clearance for movement of at least the T-nut. Despite the clearance for movement, a quick-release mount can be achieved which is completely preassembled, interconnected and ready for use. After insertion into the T-groove, which allows a gradual adjustment or displacement, the latch lever has to be pivoted against the force of the spring to securely fix the quick-release mount on the seat rail.

According to one proposal of the invention, a galley or built-in piece of equipment is carried by an array of at least four quick-release mounts. This results in a load distribution over a plurality of mounting points, for example on all walls of the galley or its assembled elements. By pivoting the latch lever into the locking position and by the resulting closure of all parts, all degrees of freedom of the loosely preassembled quick-release mount are locked.

If retrofitting is required, this is to be carried out without tools in the shortest possible time. It is only necessary to pivot the latch levers in the opposite direction, i.e. into their open position. The form- and force-fitting connection achieved with the quick-release mount according to the invention is thus released, and the kitchen or individual cabinets or the like, which are built on top of or next to each other, and which are supported by the plurality of quick-release mount, can be moved by means of the quick-release mount which slide with their T-nuts in the seat rails into the desired position. The moving properties of the quick-release mount can be enhanced if the sections of the quick-release mount that slide in the seat rails and/or the seat rail are provided with a coating which facilitates the sliding, for example Teflon.

According to a preferred embodiment of the invention the spring is a compression spring bearing against the T-nut and surrounded by a locking block fitted into the base and that surrounds a stem of the T-nut. With the latch lever open, the spring, which is completely encapsulated against the outside, pushes the locking block upward, the locking block lifting away from the T-nut and releasing it in such a manner that subsequent displacement of the complete floor mount is possible.

If, according to another advantageous proposal, the locking block has at least two sides facing the longitudinal edges of the T-groove of the guide rail and formed according to the invention as spanner flats, and preferably the locking block as a whole is square, then the locking block, which absorbs in particular the forces in the X- and Y-direction, is also suited to prevent the T-nut from jamming during the movement. It also contributes to prevent jamming of the T-nut if the base of the quick-release mount is equipped on its bottom face with guide ribs that engage in the T-groove of the guide rail.

According to a proposal of the invention, an inner and an outer eccentric bushing are concentrically arranged above the locking block in the through hole of the base. By adjusting the eccentric bushings it is possible to compensate for aircraft-related tolerances during assembly and to perform a fine adjustment.

If, preferably, the latch lever is arranged on a pressure piece, this contributes substantially to the absorption of the load transmitted to the latch lever.

One embodiment of the invention provides that the base is formed in two pieces and consists of a bottom piece and a top piece. According to another embodiment having a one-piece base, the latch lever with the pressure piece is arranged in an aperture of an upper part on the lower aperture bar. A quick-release mount having a one-piece base and an upper part arranged thereon can be designed narrower and higher because, for example, a further eccentric, if required, can be provided in the upper part to compensate for tolerances in the Z-direction.

The threaded bolt assembly that passes through the aligned bores of all the necessary parts to hold the parts together can be configured as a stud of the T-nut onto which a nut can be screwed from the latch lever side. An alternative proposal provides that the threaded bolt assembly is a screw that bears downward with its head within the latch lever and that can be screwed at its other end into the T-nut.

### BRIEF DESCRIPTION OF THE DRAWING

Further features and details of the invention are disclosed in the claims and the following description of embodiments of the invention illustrated in the drawings. Therein:

FIG. 1 is a front detail view of a quick-release mount in the locked position on an aircraft seat rail and supporting a galley part;

FIG. 2 is a section through the quick-release mount taken along line II-II of FIG. 1;

FIG. 3A is a section taken along line of FIG. 1, in the locked position;

FIG. 3B is a view like FIG. 3A but in the unlocked position;

FIG. 4 is a perspective view of the structure of FIG. 1 in the locked position;

FIG. 5 is a view like FIG. 4, but with the latch in the unlocked position;

FIG. 6 is a perspective exploded view of the quick-release mount of FIG. 1;

FIG. 7 is a perspective exploded view of a slightly different embodiment of the quick-release mount; and

FIG. 8 is a view like FIG. 7 but with a different arrangement of the threaded bolt assembly for holding the individual parts together.

### DETAILED DESCRIPTION

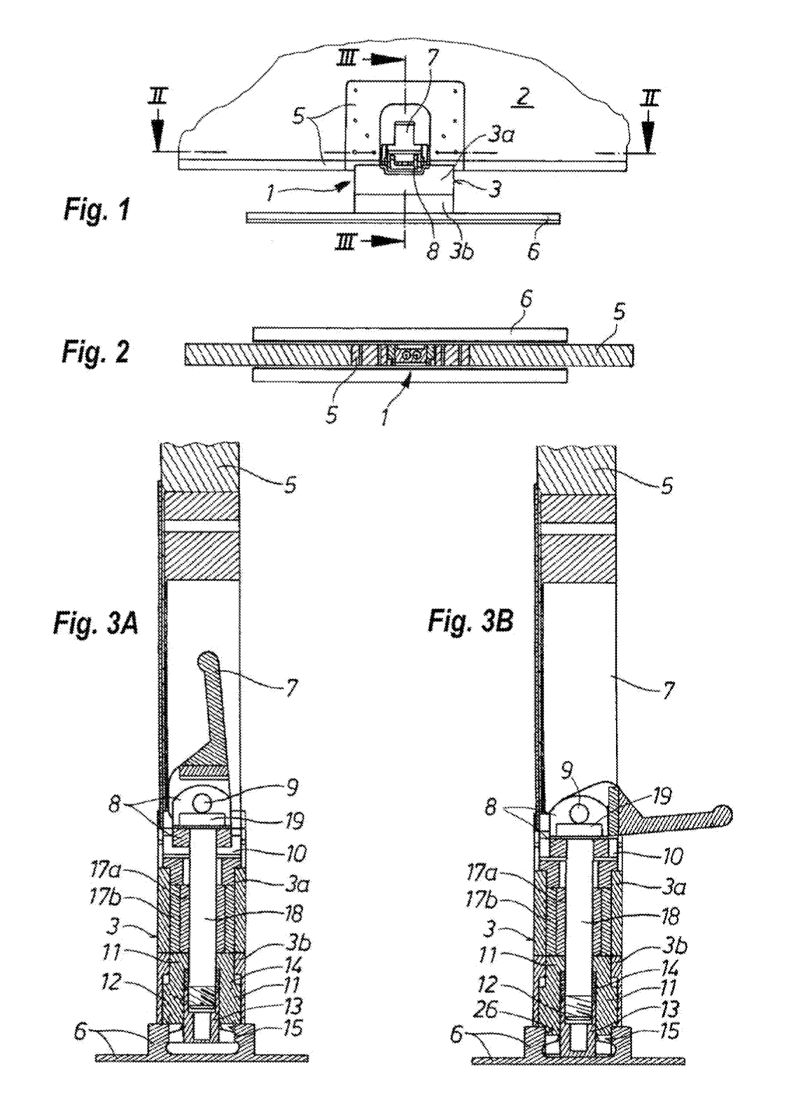

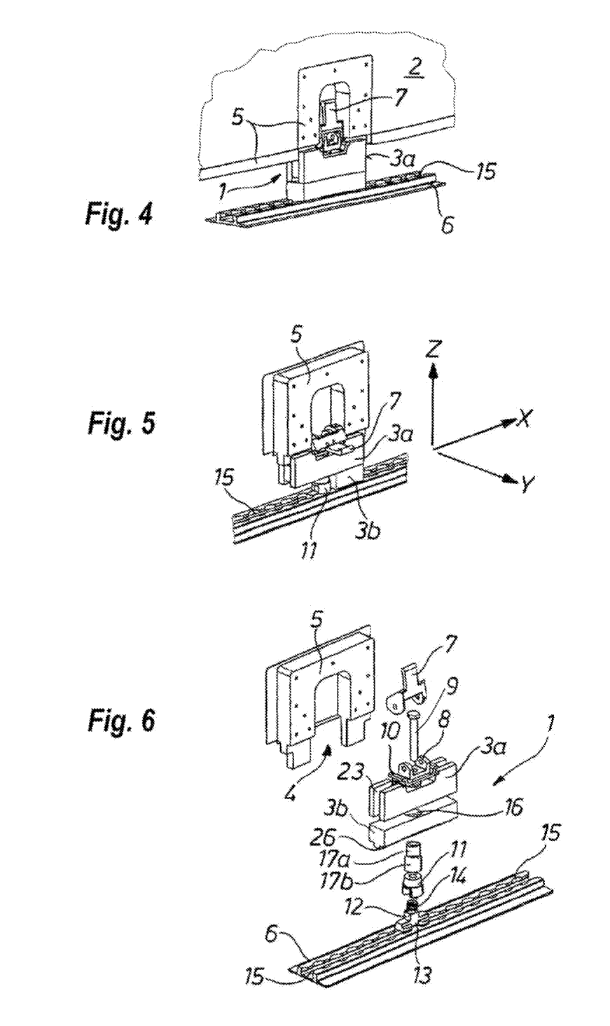

FIGS. 1 to 6 show a quick-release mount 1 that supports a galley unit 2 composed of one or more cabinets or the like, with a plurality of the quick-release mounts 1 securing it to floor-mounted rails 6. Of the galley unit 2, only a wall 5 is shown having a cutout 4 (see FIG. 6) into which is fitted a single one of the mounts 1. The wall 5 is fitted onto bases 3 of the quick-release mounts 1. Each quick-release mount 1 can extend longitudinally or transversely of the seat rails 6. In the locking position, a latch lever 7 of the quick-release mount 1 takes a position in which it is pivoted up into a generally vertical position shown in FIGS. 1-3A, 4, and 6-7, thereby engaging in a cutout of the wall 5. In contrast, FIGS. 3B and 5 show the unlocked pivot position with the lever 7 projecting generally horizontally out from the wall 5 of the galley 2.

As shown in detail in FIGS. 3A, 3B, and 6, from top to bottom, i.e. toward the seat rail 6, the latch assembly is formed by a plurality of parts. The latch lever 7 is pivotal about a pivot pin 9 in a squared-off U-shaped profile 8 and bears on the base 3 via an omega-shaped pressure piece 10 into which the profile 8 fits, with cam ends of the lever 7 bearing downward on ears of the pressure piece 10 and the profile 8 nested in the pressure piece 10. The base 3 consists of a top piece 3a and a bottom piece 3b that are normally fixed relative to each other. A vertically shiftable locking block 11 in the base or bottom piece 3b is traversed by a shaft or stem 12 of a T-nut 13 and holds a compression spring 14 braced surrounding the stem 12 and bearing upward on the block 11 and downward on the nut 13.

The T-nut 13 fits in a T-groove 15 of the seat rail 6 (see FIG. 6), which T-groove 15 is formed with a longitudinal row of downwardly open notches to allow incremental adjustment. Above the locking block 11, inner and outer bushings 17a and 17b are arranged in a through-hole 16 of the top and bottom pieces 3a and 3b. All the above-mentioned parts surround a threaded bolt 18 that passes through bores of all the parts, bores being aligned with the through-hole 16 of the base 3. The bolt 18 is threaded at its lower end into the T-nut 13 and has at its upper end a head 1 sitting atop the U-shaped profile 8 pivoted on the lever 7.

When the lever 7 is pivoted up as shown in FIG. 3a to lock the galley unit 2 to the rail 6, the ears lower part of the lever 7, whose outer surfaces form cams eccentric to an axis of the pivot 9, bear downward on the pressure piece 10 and, as the lever 7 pivots, the pivot pin 9 is raised to similarly lift the profile 8. Since the bolt head 19 is sitting on the profile 8, this movement raises the bolt 18 and pulls the T-nut upward so that it engages the notches of the rail 6 and locks the mount 1 to the rail 6.

To release the mount 1 from the rail 6 and allow the galley 2 to be slid along this rail 6 and even removed therefrom, the lever is swivelled about the pin 9 down into the position of FIG. 3b. This action drops the pin 9 so that the T-nut 13 moves down out of engagement with the notches of the rail 6.

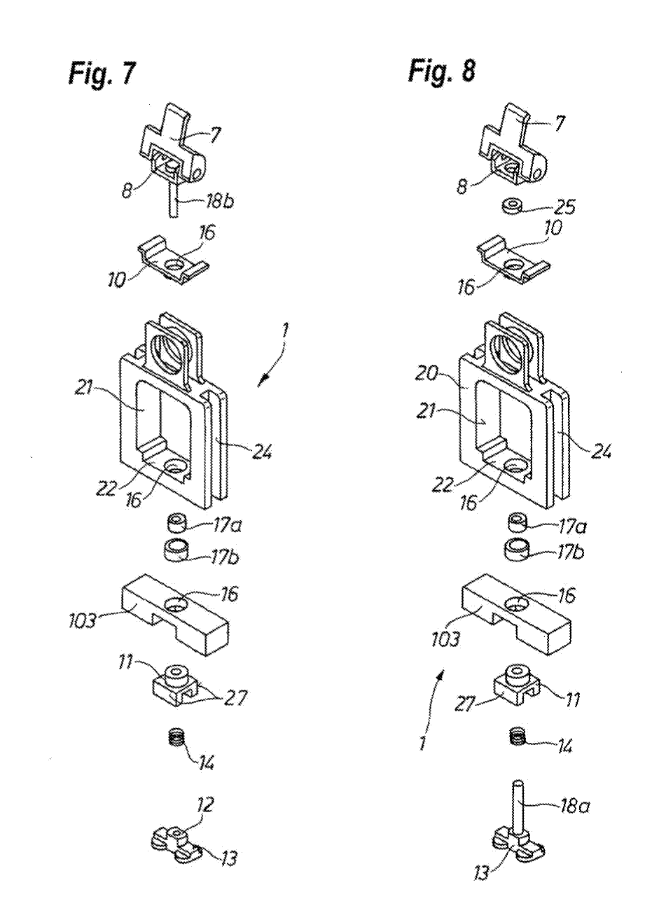

The variant of the quick-release mount 1 shown in FIGS. 7 and 8 differs from the above-described embodiment substantially only in that only a flat and narrower base 103 and a higher extending upper part 20 arranged thereabove is provided. The upper part has an aperture 21 against whose lower aperture bar 22 the pressure piece 10 with latch lever 7 and the U-shaped profile member 8 bears. While in the embodiment according to FIGS. 1 to 6, the top piece 3a is provided with end grooves 23 for interfitting with the wall 5 of the galley 2, here the upper part 20 has two such end grooves 24. In contrast to FIG. 7 in which, as in the embodiment according to FIGS. 1 to 6, the threaded bolt assembly is configured as a screw 18b which can be screwed into the T-nut 13, the threaded bolt assembly, according to FIG. 8, is an integrated stud bolt 18a of the T-nut 13, onto which a nut 25 is screwed from above in the U-shaped profile member 8.

By providing the bottom piece 3b of the base 3 (see FIG. 6) with a narrow downwardly projecting guide rib 26 or by forming the locking block 11 with flat faces 27 that extend at least along the edges of and into the T-groove 15 of the seat rail 6, jamming of the mounting means 1 during displacement in the T-grooves 15 is prevented.

In any case, the parts of quick-release mount 1 that are loosely held together by the compression spring 14 make easy displacement possible, whereas pivoting the latch lever 7 into the locking position (see FIGS. 1 and 3), effects locking onto the seat rail 6 to meet all requirements of the flight operation.

I claim:

1. In combination with an aircraft-floor rail formed with an upwardly open T-groove and with a piece of galley equipment, a mount comprising:
a base fixable on the piece of equipment and formed with an upper bearing surface and a vertically throughgoing bore opening at the surface;
a locking block below the base, engaging downward into the T-groove, and formed with a vertically throughgoing bore aligned with the bore of the base;
a T-nut fittable in and slidable along the T-groove and lockingly upwardly engageable with the rail;
a threaded bolt seated in and projecting upward from the T-nut through the bores of the base and of the locking block;
a latch lever above the locking block, operatively coupled to the bolt, engageable downwardly with the surface and movable between a locked position pulling the T-nut by the bolt up into tight engagement with the rail and an unlocked position with the T-nut slidable along the T-groove; and
a compression spring in the locking block, bearing upward on the base through the locking block and downward directly on the T-nut so as to urge the T-nut downward and away from the base, the spring lifting the locking block off the T-nut in the unlocked position of the lever.

2. The mount according to claim 1, further comprising:
an inner and an outer eccentric bushing concentrically arranged above the locking block in the bore of the base.

3. The mount according to claim 1, further comprising:
a pressure piece carrying the latch lever.

4. The mount according to claim 1, wherein the base is formed with downwardly projecting ribs that engage in the T-groove of the guide rail.

5. The mount according to claim 1, wherein the base is a two-piece part and consists of a bottom piece and a top piece.

6. The mount according to claim 1, wherein base is of one piece and the latch lever with the pressure piece is arranged in an aperture of the upper part on a lower bar of the base.

7. The mount according to claim 1, wherein the threaded bolt is formed as a stud of the T-nut onto which a nut can be screwed from the latch lever side.

8. The mount according to claim 1, wherein the threaded bolt is a screw having a head in operative bearing engagement with the latch lever and an opposite threaded end that can be screwed into the T-nut.

9. The mount according to claim 1, wherein a galley unit is arranged on an array of at least four such quick-release mounts.

10. The combination defined in claim 1, further comprising a profile on which an upper end of the bolt bears downward, the latch lever being pivotal about a longitudinal axis on the profile and having an eccentric formation bearing downward on the base.

11. The combination defined in claim 1 wherein the base is formed of a single piece formed with a central transversely throughgoing aperture in which the lever is fitted and into which an upper end of the bolt projects.

12. The combination defined in claim 1 wherein the base is formed with downwardly projecting longitudinal ribs flanking the bolt and slidable along the T-groove.

13. The combination defined in claim 1 wherein the bolt has a lower end threaded into the T-nut and an upper end provided with a head and connected to the latch lever.

14. The combination defined in claim 1 wherein the bolt is formed unitarily with the T-nut as an upwardly projecting stud having an upper end provided with a nut connected to the latch lever.

15. The combination defined in claim 1 wherein the rail is longitudinally elongated and the T-nut has a pair of arms extending longitudinally of the rail.
